(19) United States
(12) Patent Application Publication
(10) Pub. No.: US 2016/0126857 A1
(43) Pub. Date: May 5, 2016

(54) AUTOTRANSFORMER WITH WIDE RANGE OF, INTEGER TURNS, PHASE SHIFT, AND VOLTAGE

(71) Applicant: Derek Albert Paice, Palm Harbor, FL (US)

(72) Inventor: Derek Albert Paice, Palm Harbor, FL (US)

(21) Appl. No.: 14/531,148

(22) Filed: Nov. 3, 2014

(51) Int. Cl. H02M 7/06

(52) U.S. Cl. CPC H02M 7/06

(57) ABSTRACT

A new wye-type autotransformer topology provides readily designed phase shift and voltage ratios, including an exact 30° phase shift. It requires only three windings per phase and can be implemented with a wide range of integer turns, such that both high and low power ratings are feasible. An appropriate magnetic structure is used to provide high zero sequence impedance, thereby obviating the need for zero-sequence blocking transformers.

Using two mechanically identical units the new autotransformer is uniquely suited to provide balanced power supplies for 12-pulse AC to DC converters with capacitive, inductive, or resistive DC load circuit. The resulting 12-pulse current waveforms contain very small residual 5^{th} and 7^{th} harmonics. Single or multiple units provide a cost effective means to increase the effective pulse number and reduce harmonic distortion in AC to DC power converters.

### PRIORITY CLAIM

The present invention claims the benefit of the filing date of U.S. Provisional Patent Application No. 62/008,693 filed on Jun. 6, 2014.

### FIELD OF THE INVENTION

The invention relates to static AC to DC power converters such as can be used for AC or DC motor drive systems.

### REFERENCES CITED

U.S. Patent Documents

| | | |
|---|---|---|
| 6,982,884 | January 2006 | Paice |
| 7,049,921 | May 2006 | Owen |

### OTHER PUBLICATIONS

“Power Electronic Converter Harmonics” by Derek A. Paice, published 1995 by the IEEE Press, ISBN 0-7803-1137-X

### BACKGROUND OF THE INVENTION

To meet industry needs for electrical power converters which convert AC to DC without injecting large amounts of harmonic currents into the power system, multipulse AC to DC converters are used. Industry has a wide range of requirements including 12-, 18-, and 24-pulse designs. Also, step-up and step-down of voltage may be needed. These requirements can be met with double-wound transformers of appropriate power rating, but means to reduce transformer cost and improve efficiency are continually sought. Autotransformer methods greatly help and 18-pulse systems are widely used. However, in some cases a less exacting performance is required and 12-pulse is acceptable. This invention helps overcome limitations of existing 12-pulse methods using autotransformers. In its preferred embodiment it ensures that the voltage and impedance of two phase shifted supplies are precisely balanced such that they can supply two 6-pulse converters and achieve excellent 12-pulse performance. Not only that, the invention gives a very simple means for step-up, or step-down voltage. The invention can also be applied to higher pulse number converters.

### BRIEF DESCRIPTION OF THE INVENTION

A three-phase, three-winding, wye connected autotransformer with isolated neutral and appropriate turns ratio provides a phase shifted output of the required output voltage and phase shift for one or more 6-pulse converters in an assembly designed to provide multipulse output. Such multipulse converters provide reduced distortion of the AC power source current and a smoother DC output voltage.

The invention is especially suitable for application of 12-pulse converters, but can be applied to other configurations such as 18-, 24-, 30-, and 36-pulse. It provides a very simple means for obtaining step-up and step-down of output voltage.

Two mechanically identical units of the invention provide balanced impedances such that near perfect performance of 12-pulse converters can be obtained. Use of two units also provides potential for reducing the equipment footprint. For practical values of coil resistance and leakage reactance, each transformer has an equivalent kVA rating that is about 24.8% of the total 12-pulse converter DC load kw.

The invention competes very favorably with the topology in U.S. Pat. No. 6,982,884 because it offers a simpler range of voltage adjustment and wider range of practical turns ratios. Also, it can provide a precise 30° phase shift when this is required.

U.S. Pat. No. 7,049,921 also utilizes a wye type connection to obviate the need for a zero-sequence blocking transformer, but uses a single transformer with four windings per phase. The use of an additional winding makes it more difficult to obtain perfectly balanced output impedances, also a precise phase shift is not easily obtained. Further, the footprint of a single transformer has little flexibility during installation.

### BRIEF DESCRIPTION OF THE DRAWINGS

FIG. 1 Shows the prior art of U.S. Pat. No. 6,982,884. Three windings are shown on each phase by means of rectangular blocks alongside which are the associated turns labeled n1, n2, and n3. Input voltage is applied to nodes, A, B, and C. A phase-shifted output of nominally the same amplitude is obtained at nodes 1, 2, and 3. Output current, i1, flows from terminal land for an assumed phase rotation of A, B, C, is indicated to be leading in the figure. A second output current, i2, shown emanating from node 2 is used during analysis. The phase-shift angle is shown as φ. Angle (120−φ) shown in the figure is a geometrical construct to facilitate analysis.

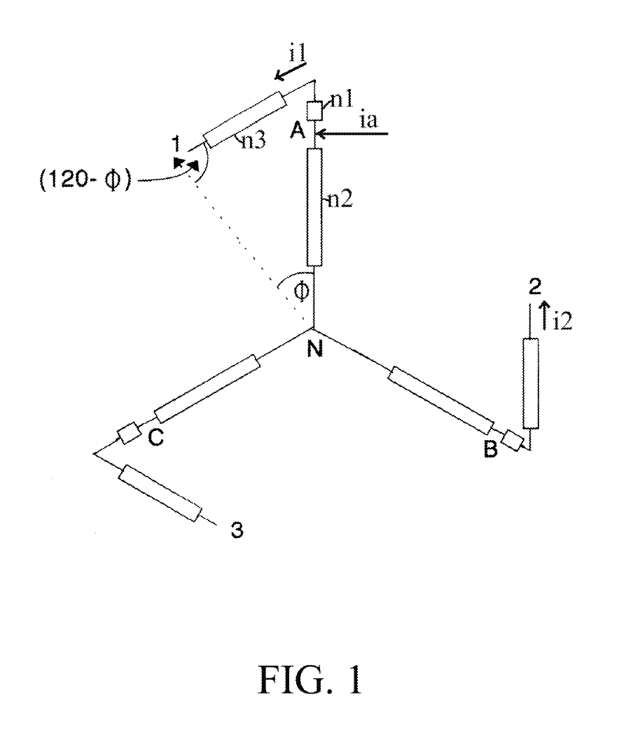

FIG. 2 shows the windings of the invention. Three windings are shown on each phase by means of rectangular blocks alongside which are associated turns labeled n1, n2, and n3. Input voltage is applied to nodes, A, B, and C. Common windings on each phase terminate at a neutral point N. Input current, ia, is shown to enter the transformer at node A. Output currents i1 and i2 are shown to leave at nodes 1 and 2 respectively. A current, iy, flows in turns n1. For an assumed phase rotation of A, B, C, the output current, i1, is seen to be at a lagging angle of φ. If the phase rotation of the power source is reversed the sign of the phase shift is reversed, e.g., a lagging phase shift becomes a leading phase shift. If n1 and n2 have equal turns the phase shift is exactly 30°.

FIG. 3 shows a sample schematic in which the invention is used to power a 12-pulse AC to DC converter. The transformer windings are shown as rectangular blocks. Labeled nodes are used to define connection points. Nodes A, B, and C connect to a three-phase power source and the autotransformer provides output at nodes 1, 2, 3. Rectifier bridge #1 receives power from the transformer output nodes 1, 2, 3. The power source at nodes A, B, C is also applied to a three-phase inductor with output nodes 4, 5, 6 that connect to nodes 4, 5, 6 on rectifier bridge #2. The inductor provides means to control the source impedance seen by rectifier bridge #2. The positive (+ve) and negative (−ve) DC outputs from the two rectifier bridges are paralleled to supply a DC load. By correctly selecting turns on the autotransformer invention, a nominally 1:1 voltage ratio and precise 30° phase-shifted supply is fed to rectifier bridge #1. By these means the two rectifier bridges act as a 12-pulse AC to DC converter.

FIG. 4 gives an example using two mechanically identical transformers of the invention. In this drawing the transformer windings are again shown as rectangular blocks. Numbered nodes define connection points. Nodes A, B, and C connect to a three-phase power source and the transformers provide two sets of three-phase outputs, namely, at nodes, 1, 2, 3 and 4, 5, 6. The transformers provide a lag phase shift output at nodes 1, 2, 3 and lead phase shift output at nodes 4, 5, 6, for an assumed input voltage phase rotation of A, B, C. Rectifier bridge #1 is fed from AC voltages at nodes 1, 2, 3. Rectifier bridge #2 is fed from AC voltages at nodes 4, 5, 6. Outputs of the two rectifiers are paralleled to feed a DC load with +ve and −ye polarity. By proper selection of the transformer turns, the output voltage ripple on the DC load is 12 times the AC input frequency. Also, harmonic currents drawn from the AC supply are those of a 12-pulse system.

### DESCRIPTION OF THE INVENTION

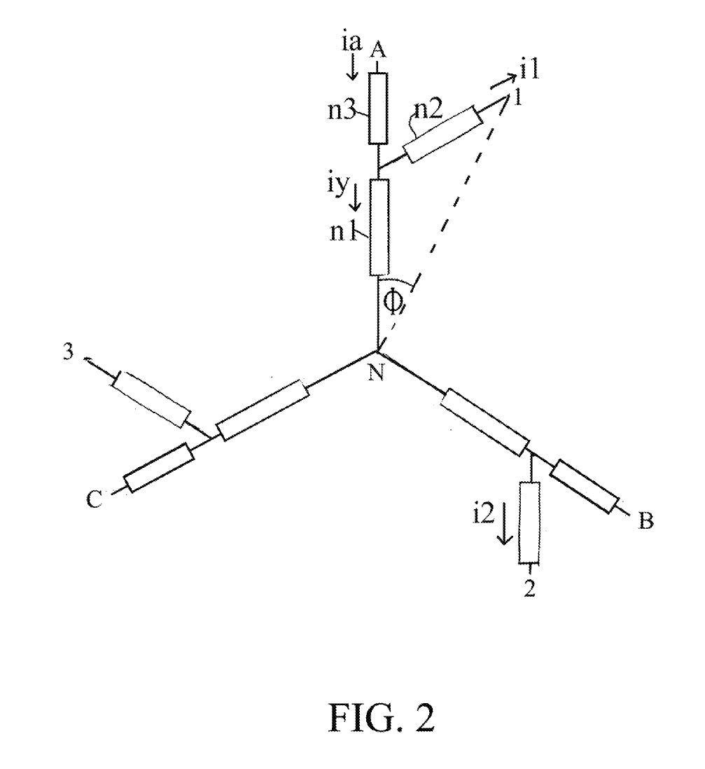

Analysis of the topology in FIG. 2 results in the two important performance equations below.

$$\begin{matrix}Phase shift , ϕ = arctan \frac{\sqrt{3}}{( 1 + 2 n 1 \text{/} n 2 )} & Eq ( 1 ) \\ \frac{Output voltage at nodes 1 , 2 , 3}{Input voltage at nodes A , B , C} = \frac{\sqrt{{( n 1 + n 2 )}^{2} - n 1 n 2}}{( n 1 + n 3 )} & Eq ( 2 )\end{matrix}$$

Eq (1) shows that phase shift φ is dependent only on selection of turns n1 and n2. Also, it is noted that if n1=n2 the phase shift is exactly 30°. The general formula for output voltage is less simple, but the normal design method is to first select turns n1 and n2. Once this is done, it is relatively straightforward to determine the ratio of output to input voltage by observing the voltage divider relationship between n1 and (n1+n3). For example, output voltage/input voltage varies with n1/(n1+n3).

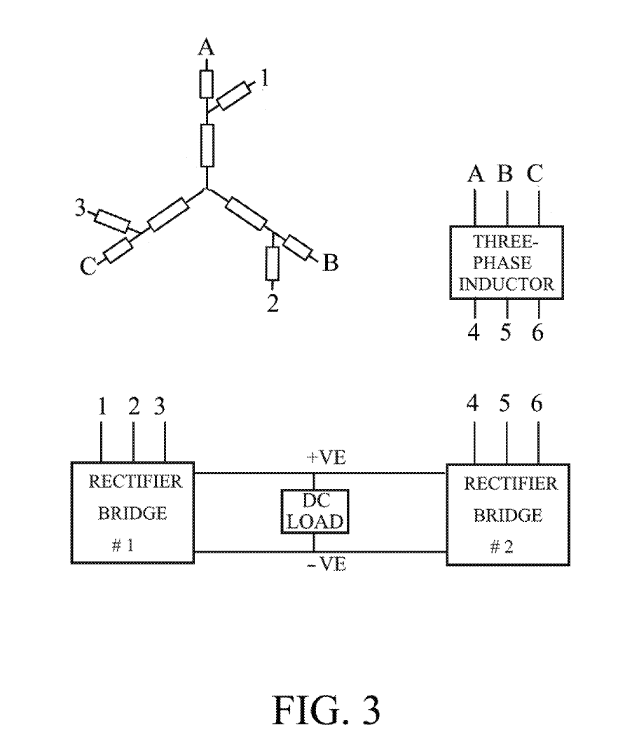

If a single unit of the invention is used to obtain a 12-pulse output, as in FIG. 3, the desired phase shift is 30°. The ratio of output and input voltages Vout/Vin, should typically be 1.0±0.5%. Table 1 gives examples of integer turns that meet these conditions. They cover a range of 3.18 to 14.57 volts/turn for a 480 V system. This is adequate for many practical applications.

TABLE 1
(ZS = Zero Sequence)
HIGH ZS IMPEDANCE WYE TRANSFORMER WITH 30° SHIFT
AND VOLTAGE RATIO 1.00 PLUS/MINUS 0.5%

| n1 turns | n2 turns | n3 turns | Phase angle | Vout/vin |
|---|---|---|---|---|
| 50 | 50 | 37 | 30 | 0.995 |
| 49 | 49 | 36 | 30 | 0.998 |
| 48 | 48 | 35 | 30 | 1.002 |
| 47 | 47 | 34 | 30 | 1.005 |
| 46 | 46 | 34 | 30 | 0.996 |
| 45 | 45 | 33 | 30 | 0.999 |
| 44 | 44 | 32 | 30 | 1.003 |
| 42 | 42 | 31 | 30 | 0.997 |
| 41 | 41 | 30 | 30 | 1.000 |
| 40 | 40 | 29 | 30 | 1.004 |
| 38 | 38 | 28 | 30 | 0.997 |
| 37 | 37 | 27 | 30 | 1.001 |
| 34 | 34 | 25 | 30 | 0.998 |
| 33 | 33 | 24 | 30 | 1.003 |
| 30 | 30 | 22 | 30 | 0.999 |
| 29 | 29 | 21 | 30 | 1.005 |
| 27 | 27 | 20 | 30 | 0.995 |
| 26 | 26 | 19 | 30 | 1.001 |
| 23 | 23 | 17 | 30 | 0.996 |
| 22 | 22 | 16 | 30 | 1.003 |
| 19 | 19 | 14 | 30 | 0.997 |
| 15 | 15 | 11 | 30 | 0.999 |
| 11 | 11 | 8 | 30 | 1.003 |

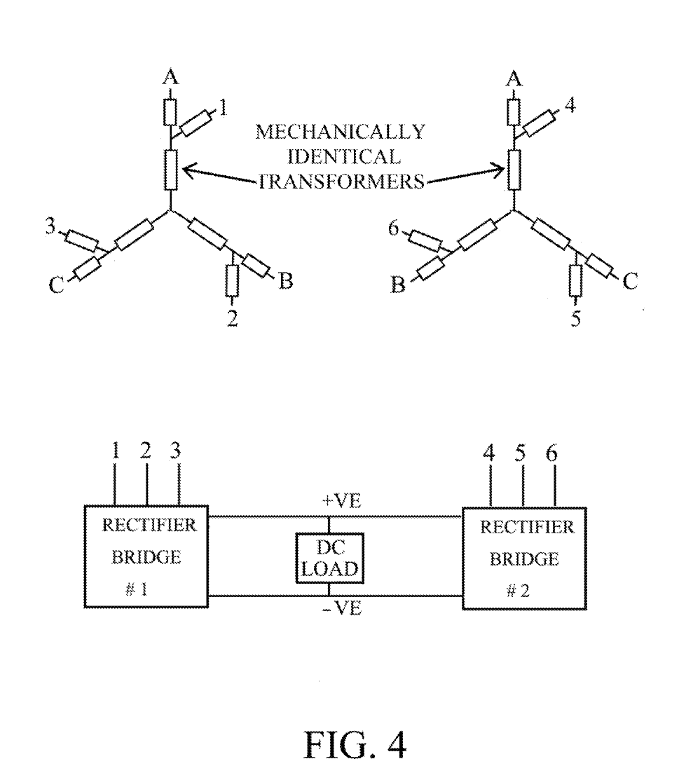

A preferred embodiment of the invention is shown in FIG. 4. This topology uses two identical units of the invention each designed to produce a phase shift of nominally 15°, ±0.25°. Use of two mechanically identical units ensures balanced voltage and impedance for each output, thereby ensuring excellent 12-pulse operation. The ratio of output to input voltage, Vout/Vin, is simply selected to provide the user's requirements. Possible turns combinations for a nominal 1:1 voltage ratio are given in table 2. These turns cover a range of 3.55 volts/turn to 21.3 volts/turn for an input voltage of 480 V. This is adequate for many practical applications

TABLE 2
(ZS = Zero-Sequence)
HIGH ZS IMPEDANCE WYE TRANSFORMER
WITH NOMINAL 15° SHIFT

| n1 turns | n2 turns | n3 turns | Phase angle | Vout/Vin |
|---|---|---|---|---|
| 64 | 23 | 14 | 14.779 | 1.001 |
| 63 | 23 | 14 | 14.969 | 1.002 |
| 62 | 23 | 14 | 15.163 | 1.002 |
| 61 | 22 | 14 | 14.822 | 0.993 |
| 60 | 22 | 13 | 15.021 | 1.007 |
| 59 | 22 | 13 | 15.226 | 1.008 |
| 58 | 21 | 13 | 14.869 | 0.998 |
| 57 | 21 | 13 | 15.079 | 0.999 |
| 55 | 20 | 12 | 14.921 | 1.004 |
| 54 | 20 | 12 | 15.143 | 1.005 |
| 52 | 19 | 12 | 14.979 | 0.995 |
| 51 | 19 | 11 | 15.215 | 1.011 |
| 50 | 18 | 11 | 14.800 | 1.000 |
| 49 | 18 | 11 | 15.044 | 1.001 |
| 47 | 17 | 11 | 14.857 | 0.990 |
| 46 | 17 | 10 | 15.117 | 1.008 |
| 44 | 16 | 10 | 14.921 | 0.997 |
| 43 | 16 | 10 | 15.200 | 0.997 |
| 41 | 15 | 9 | 14.994 | 1.004 |
| 39 | 14 | 9 | 14.766 | 0.991 |
| 38 | 14 | 9 | 15.079 | 0.992 |
| 36 | 13 | 8 | 14.837 | 0.999 |
| 35 | 13 | 8 | 15.178 | 1.000 |
| 33 | 12 | 7 | 14.921 | 1.009 |
| 30 | 11 | 7 | 15.021 | 0.993 |
| 27 | 10 | 6 | 15.143 | 1.005 |
| 25 | 9 | 6 | 14.800 | 0.984 |
| 22 | 8 | 5 | 14.921 | 0.997 |
| 19 | 7 | 4 | 15.079 | 1.013 |
| 11 | 4 | 2 | 14.921 | 1.035 |

### ADVANTAGES OF THE INVENTION

Significant advantages are evident from inspection of the new topology, namely:
1. Phase shift is uniquely determined by only two windings, namely, n1 and n2.
2. An exact phase shift of 30° is available by making n1 and n2 equal.
3. Only three windings are required for any output voltage ratio from near zero to √3.
4. Step up and step down of in-phase outputs can be simply obtained by tapping winding n1.
5. A large range of integer turn ratios is available for practical designs.
6. In the preferred embodiment of the invention shown in FIG. 4, two mechanically identical units providing nominally 15° phase shift ensure balanced voltage and impedance. Excellent 12-pulse operation is assured.
7. Additional units of the invention can be applied to obtain system pulse numbers greater than 12-pulse, for example, 18- 24- 30- and 36-pulse. Interconnection of multiple units of the invention with appropriate turns ratio and phase shift will be clear to those skilled in the art.

What I claim as my invention is:

1. Multipulse AC/DC converter systems comprising single or multiple 3-phase wye-connected autotransformers with isolated neutral(s) and constructed to have three windings on each of three phases;
with said three windings on each phase including two serial windings with one end of said serial windings connected to a neutral point;
with the ends of said serial windings not connected to the neutral point being connected to a three-phase power source;
with the junction point of said two serial windings being connected to a third winding from another phase coil;
with the ends of said third windings from another phase coil providing three output points;
with said three output points providing output voltages with different phase angle relative to the phase of the three-phase input source;
with said phase angle having a range varying from nearly 0° to exactly 30° to nearly 60° depending on the number of turns on each winding;
with said output voltage amplitudes being greater than, or less than, or equal to the supply voltage depending on the number of turns on each winding;
with each phase being so connected as to form a three-phase wye-connected autotransformer with designed three-phase output voltage and phase shift.

2. The system of claim 1 wherein each wye connected autotransformer exhibits high zero-sequence impedance;
with said high zero-sequence impedance being obtained by using a core type magnetic structure with four or five iron limbs, or a shell type magnetic structure with three iron limbs.

3. Practically identical pairs of the autotransformer in claim 2 being used to provide plus and minus phase shifts of output voltages by means of reversing the sequence of applied input voltage.

4. Single or multiple autotransformers as in claim 2 wherein one of said two serial windings is tapped to provide an additional output with the same phase but different amplitude from that of the AC supply source.

5. The system of claim 3 in which (n) or (n−1) autotransformers are used to supply a quantity of (n) three-phase bridge converters so as to construct a multipulse converter having line current harmonics generally of frequency (6n±1) with amplitude relative to the fundamental current of generally 1/(6n±1).

6. The system of claim 5 wherein a 3-phase reactor is connected in series with AC/DC converter bridges not connected to the phase-shifted outputs of the autotransformer.
